(19) United States
(12) Patent Application Publication
(10) Pub. No.: US 2025/0167281 A1
(43) Pub. Date: May 22, 2025

(54) METHOD AND DEVICES FOR MANUFACTURING MONO CELLS AND CELL STACKS FOR BATTERIES FORMED FROM THE MONO CELLS

(71) Applicant: GROB-WERKE GmbH & Co. KG, MINDELHEIM (DE)

(72) Inventors: Patrick HIERL, DIRLEWANG (DE); Alexander FRITZ, SCHIESSEN (DE); Moritz GLÜCK, POLLING (DE)

(21) Appl. No.: 18/954,912

(22) Filed: Nov. 21, 2024

(30) Foreign Application Priority Data
Nov. 22, 2023 (DE) 102023132600.7
Jan. 16, 2024 (EP) 24152205.1

(51) Int. Cl. H01M 10/04; H01M 50/204

(52) U.S. Cl. CPC H01M 10/0468; H01M 10/0404; H01M 50/204

(57) ABSTRACT

A mono-cell manufacturing method for producing mono cells for a battery, wherein the mono cell has a first electrode segment, a second electrode segment and a separator layer between the first electrode segment and the second electrode segment, and at least one separator layer on a facing-away surface of the first and/or second electrode segment. The method includes: providing a first electrode string having a first separator web and first electrode segments attached and fixed thereto at a distance from one another; positioning and direct lamination of second electrode segments and a second separator web on the first electrode string so that the first and second electrode segments are superposed in alignment with one another; and cutting the mono cells from the composite string. Also a device and a controller for same.

### CROSS-REFERENCES TO RELATED APPLICATIONS

This application claims the benefit of German Patent Application Number 102023132600.7 filed on Nov. 22, 2023 and European Patent Application Number 24152205.1 filed on Jan. 16, 2024, the entire disclosures of which are incorporated herein by way of reference.

### FIELD OF THE INVENTION

The invention relates to a mono-cell manufacturing method for manufacturing mono cells for a battery, each mono cell having a first electrode segment, a second electrode segment and a separator layer between the first electrode segment and the second electrode segment, and at least one separator layer on a facing-away surface of the first and/or second electrode segment. Furthermore, the invention relates to a battery cell stack manufacturing method for manufacturing a cell stack for a battery using a mono-cell manufacturing method of this kind. The invention also relates to a mono-cell manufacturing device for manufacturing mono cells of the above-mentioned type for a battery and to a cell stack manufacturing device equipped with a mono-cell manufacturing device of this kind. Finally, the invention relates to a computer-implemented control system for such devices.

The invention relates in particular to the field of automated and computer-aided production of mono cells and battery stacks made from such mono cells.

### BACKGROUND OF THE INVENTION

For the technological background, reference is made to the following literature:
[1] WO 2020/192 845 A1
[2] DE 10 2017 216 156 A1
[3] EP 3 955 364 A1
[4] EP 3 471 188 B1
[5] EP 3 069 407 B1

From [1], methods and devices for providing electrode strings and for manufacturing mono cells and battery stacks formed from them are known. In particular, [1] describes a system for producing battery cells in which an anode string with anodes (A) attached to a first web-like separator(S) and a cathode string with cathodes (K) attached to a second web-like separator(S) are provided as electrode strings, with a string composite being formed from this, from which mono cells are separated. In contrast to the Z-folding process for battery cells, this is a continuous process. The advantage here is the higher output due to a continuous process. To this end, separator, anode, separator, cathode (SASK) are laminated together in the following order in the system. The basis for the battery cell is created by stacking the individual SASK layers.

In reference [2], a method for manufacturing mono cells is described in which the separator is first sucked onto a vacuum belt. At the same time, electrodes are sucked onto a drum and separated by a laser. The separated electrode is transferred to the separator and sucked through it onto the vacuum belt. A second separator is placed on top and then transferred to a transport system with transport units that can be moved individually on a guideway (sometimes also called a mover system). Here the separator web is cut and another electrode, which is prepared in the same way as the first, is placed on top. The stack is clamped mechanically and transported to the discharge point.

Reference [3] also refers to the production of mono cells from anode, cathode and two separators. In the first step, the first electrode is separated and laminated onto the separator. This half-cell string is then supplied to a second process. There, the pre-separated electrode and the separator for the second half-cell are additionally introduced. Initially, only the second electrode is positioned in relation to the first electrode in the half-cell string and the second separator is placed over it. This combination is conveyed loosely to a laminating station by means of a vacuum belt only. The lamination of the first half-cell with the second electrode and the second separator takes place after the sheets have been positioned and combined. The problem is that the electrodes can migrate on the separator on their way to the laminating point.

A basic structure of a battery cell is described in reference [4]. To produce it, a package is first created from three layers, with a first separator, a second separator and an electrode in between. The second electrode is then added.

Reference [5] also describes a method for manufacturing the mono cell. In the first step, a three-layer structure of separator-anode-separator (or also cathode) is created and laminated together. The respective other electrode is then subsequently applied to the composite and laminated. The cell stack is then produced by subsequently separating the mono cells.

### SUMMARY OF THE INVENTION

The invention is based on the problem of improving methods and devices for manufacturing mono cells for industrial mass production, particularly with regard to technically simpler construction. To solve this problem, the invention provides the methods and devices according to one or more embodiments described herein.

According to a first aspect thereof, the invention provides a mono-cell manufacturing method for producing mono cells for a battery, each mono cell having a first electrode segment, a second electrode segment and a separator layer between the first electrode segment and the second electrode segment, and at least one separator layer on a facing-away surface of the first and/or second electrode segment, the mono-cell manufacturing method comprising the steps of:
A) providing a first electrode string comprising a first separator web and first electrode segments attached and fixed thereto in a spaced-apart relationship;
B) positioning and directly laminating second electrode segments and a second separator web on the first electrode string such that the first and second electrode segments are superposed in alignment with one another,
C) cutting the mono cells from the composite string obtained in step B).

In some embodiments, the first electrode segments are anode segments and the second electrode segments are cathode segments. In some embodiments, the first electrode segments are cathode segments and the second electrode segments are anode segments.

Preferably, step B) comprises the step of:
B1) transferring individual second electrode segments in a precisely positioned manner onto a transport device with heating device, in particular a vacuum heating roller.

Preferably, step B) comprises the step of:
B2) heating the second electrode segment in a targeted manner.

Preferably, step B) comprises the step of:
B3) lifting the second electrode segments onto a fixing point located above a cutting plane in which the second electrode segments are separated.

Step B) preferably comprises the step of:
B4) laminating the first electrode string, in particular the first separator web of the first electrode string, and the second electrode segment between two rollers, optionally together with the second separator web.

Preferably, step B) comprises the step of:
B5) laminating the first electrode string, in particular the first separator web of the first electrode string, and the second electrode segment, optionally together with the second separator web, between uncoated hard metal surfaces and/or between two hard surfaces.

In some embodiments, the direct lamination of the second electrode segment onto the first electrode string-optionally together with the second separator web-takes place between coated surfaces, in particular between coated hard metal surfaces, at least one of which being formed in particular as a roller surface.

Step B) preferably includes step of:
B6) cleaning a side of the second electrode segment that has been lifted by a transport unit for delivering the second electrode segment.

Step B) preferably includes step of:
B7) pressing the first electrode string by means of a laminating roller onto a vacuum heating roller or tempered roller or externally tempered vacuum roller that transports the second electrode segments.

Preferably, step B) comprises the step of:
i) providing a web-like second electrode substrate in order to separate second electrode segments therefrom.

Preferably, step B) comprises the step of:
ii) picking up a web-like second electrode substrate or picking up second electrode segments by means of a transport system which has transport units that can be moved individually along a guideway.

Preferably, step B) comprises the step of:
iii) moving a second electrode substrate in a planar manner along a cutting plane and cutting the web-like second electrode substrate in the cutting plane in order to cut off second electrode segments, in particular in such a way that these are each arranged individually on one of the transport units of a transport system.

Preferably, step B) comprises the step of:
iv) setting a distance between second electrode segments by means of relative movement of transport units of a transport system in order to position the second electrode segments relative to one another.

Preferably, step B) comprises the step of:
v) applying and fixing the relatively positioned second electrode segments on the first electrode string.

Preferably, step B) comprises the steps of:
vi) providing the second separator web and
vi.1) applying and fixing the second separator web together with the second electrode segments on the first electrode string or
vi.2) applying and fixing the second separator web on the first electrode string to which the second electrode segments are applied and fixed.

Step ii) preferably comprises the step of:
ii.1) sucking the web-like second electrode substrate or already separated second electrode segments at a pick-up point on the transport units.

Preferably, step ii) comprises the step of:
ii.2) transporting the web-like second electrode substrate by means of the transport units to a separating point where a flat surface for cutting is provided as a cutting plane.

Preferably, step ii) comprises the step of:
ii.3) providing transport units with exchangeable product carriers, the product carriers being selected from a range of different product carriers corresponding to the electrode format of the second electrode segments.

Preferably, step iii) comprises the step of:
iii.1) providing a horizontal cutting plane and horizontal movement along the cutting plane.

Preferably step iii) comprises the step of:
iii.2) providing a substantially vertical cutting plane and movement along this cutting plane.

Preferably step iii) comprises the step of:
iii.4) cutting on a flat surface.

Preferably step iii) comprises the step of:
iii.5) cutting along a flat cutting contour for forming side edges of the second electrode segment.

Preferably, step iii) comprises the step of:
iii.6) cutting by means of a guided laser beam.

Preferably, step iii) comprises the step of:
iii.7) cutting out arrester tabs at at least one side edge of the second electrode segment.

Preferably, step iii) includes the step of:
iii.8) performing a two-dimensional laser cut within the cutting plane.

Preferably, step iii) includes the step of:
iii.9) cleaning the second electrode segment (36.2) after cutting.

Preferably, step iv) comprises the step of:
iv.1) adjusting the distance by means of control software.

Preferably, step iii) comprises the step of:
iv.2) moving a transport unit carrying a second electrode segment, which has just been cut, away from a cutting or separating point.

Preferably, step iii) includes the step of:
iv.3) further transporting the second electrode segment to a device for performing step v).

Preferably, step iii) comprises the step of:
iv.4) omitting a second electrode segment at a location that would otherwise to be filled with a second electrode segment, in order to enable the production of a half-cell, such as in particular an SAS or SKS package, in the process of manufacturing mono cells.

Preferably, step iii) comprises the step of:
iv.5) cleaning the cut-off second electrode segment and/or the transport unit.

In some embodiments, step B) comprises the steps of:
B.1) omitting a second electrode at a plurality of locations such that in each case an empty section is formed having the same predetermined length as the first electrode half-cell section which is formed from a length section of the second separator web without a second electrode, and
B.2) aligning each empty section with a first electrode segment so that a final cell region is formed in each of the multiple locations in the composite string formed in step B), which final cell region has a layered structure consisting of a length section of the first separator layer, the first electrode segment and a length section of the second separator layer, but no second electrode segment.

Preferably, step C) comprises the step of:
C1) separating the final cell regions from the composite cell string in order to obtain final cells which have a layered structure consisting of separator, first electrode and separator.

It is preferred that step A) comprises:
a) providing a web-like first electrode substrate;
b) picking up the web-like first electrode substrate by means of a first transport system which has transport units that can be moved individually along a guideway, and moving the first electrode substrate evenly along a cutting plane;
c) cutting the web-like first electrode substrate in the cutting plane in order to cut off first electrode segments, each of which is individually arranged on one of the transport units;
d) adjusting a distance between cut first electrode segments by means of relative movement of the transport units in order to position the electrode segments relative to one another;
e) providing the first separator web;
f) applying and fixing the first electrode segments positioned relative to one another on the first separator web.

Preferably, step b) comprises the step of:
b1) sucking the web-like first electrode substrate at a pick-up point on the transport units.

Preferably, step b) comprises the step of:
b2) transporting the web-like first electrode substrate by means of the transport units to a separating point where a flat surface for cutting is provided as a cutting plane.

Preferably, step b) comprises the step of:
b3) providing transport units having exchangeable product carriers, the product carriers being selected from a range of different product carriers according to the electrode format of the first electrode to be produced.

Preferably, step b) comprises the step of:
b4) providing a horizontal cutting plane and horizontal movement along the cutting plane.

Preferably step b) comprises the step of:
b5) providing a substantially vertical cutting plane and movement along this cutting plane.

Preferably, step c) comprises the step of:
c1) cutting on a flat surface.

Preferably, step c) comprises the step of:
c2) cutting along a flat cutting contour for forming side edges of the first electrode segment.

Preferably, step c) comprises the step of:
c3) cutting by means of a steered laser beam.

Preferably, step c) comprises the step of:
c4) cutting out arrester tabs on at least one side edge of the first electrode segment.

Step c) preferably comprises the step of:
c5) performing a two-dimensional laser cut within the cutting plane.

Preferably, step c) comprises the step of:
c6) cleaning the first electrode segment (36.1) after cutting.

Preferably, step d) comprises the step of:
d1) adjusting the distance by means of control software.

Preferably, step d) comprises the step of:
d2) moving a transport unit (62) which carries a first electrode segment that has just been cut off away from a cutting or separating point.

Preferably, step d) comprises the step of:
d3) further transporting the cut first electrode segment to a device for performing step f).

Step d) preferably comprises the step of:
d4) omitting a first electrode segment at a location on the separator that would otherwise to be filled with an electrode segment, in order to enable the production of a half cell, such as in particular an SAS or SKS package, in the process of manufacturing mono cells.

Preferably, step d) comprises the step of:
d5) cleaning the cut-off first electrode segment and/or the transport unit.

Preferably, step f) comprises the step of:
f1) transferring the separated first electrode segments in a precisely positioned manner onto a first transport device with a heating device, in particular a first vacuum heating roller.

Preferably, step f) comprises the step of:
f2) heating of the first electrode segment in a targeted manner.

Step f) preferably comprises the step of:
f3) lifting of the first electrode segments to a fixing point located above the cutting plane.

Step f) preferably comprises the step of:
f4) laminating the first separator web and the first electrode segment between two rollers.

Step f) preferably comprises the step of:
f5) laminating the first separator web and the first electrode segment between uncoated hard metal surfaces and/or between two hard surfaces.

In some embodiments, the first electrode segment is laminated onto the first separator web between coated surfaces, in particular between coated hard metal surfaces, at least one of which is in particular formed as a roller surface.

Preferably, step f) comprises the step of:
f6) cleaning a side of the first electrode segment that has been lifted off from the transport unit.

Preferably, step f) comprises the step of:
f7) pressing the first separator web by means of a laminating roller onto a vacuum heating roller or tempered roller or externally tempered vacuum roller that transports the first electrode segments.

According to a further aspect, the invention provides a battery cell stack manufacturing method for manufacturing a cell stack for a battery, comprising performing the mono-cell manufacturing method according to any one of the above-described configurations and stacking the mono cells manufactured thereby to form a cell stack.

In some embodiments, the stacking step comprises:
D1) starting or ending stacking with an end cell obtained in step C1) so that each battery cell stack is finished with a first electrode and a separator at each end.

In some embodiments, the stacking step comprises:
D2) forming a plurality of battery cell stacks at a plurality of stacking positions that are arranged one behind the other in a transport direction of the mono cells and end cells.

In some embodiments, the stacking step comprises:
D3) starting each battery cell stack with an end cell.

Preferably, step B.1) of the mono cell manufacturing method carried out in the course of the battery cell manufacturing method comprises the step of:
B.1.a) flexibly creating an empty section in response to a control command.

Preferably, step B.1) of the mono-cell manufacturing method carried out in the course of the battery cell manufacturing method comprises the step of:
B.1.b) creating empty sections depending on a number of cells in one or more of the battery cell stacks being produced in step e).

Preferably, step B.1) of the mono-cell manufacturing method carried out as part of the battery cell manufacturing method comprises the step of:
b.1.c) creating empty sections depending on a filling level of stack locations.

According to another aspect, the invention provides a mono-cell manufacturing apparatus comprising an electrode string providing means for providing a first electrode string having a first separator web and first electrode segments attached and fixed thereto in a spaced-apart relationship,
a positioning and laminating device that is configured to position second electrode segments on the first electrode string in alignment with the first electrode segments and to directly laminate the second electrode segments and a second separator layer onto the first electrode string, and a separator device for separating mono cells by cutting from the string obtained by the positioning and laminating device.

Preferably, the positioning and laminating device or the electrode string providing device or both of these devices have an electrode substrate providing device for providing a web-like electrode substrate.

Preferably, the positioning and laminating device or the electrode string providing device or both of these devices have a transport system which has transport units that can be moved individually along a guideway, the transport system being designed to receive the web-like electrode substrate provided by the electrode substrate providing device and to move it evenly along a cutting plane.

Preferably, the positioning and laminating device or the electrode string providing device or both of these devices have a cutting device for cutting the electrode substrate along a cutting contour running in one or two dimensions in the cutting plane, in order to cut electrode segments from the electrode substrate.

Preferably, the positioning and laminating device or the electrode string providing device or both of these devices have a separator web providing device for providing a separator web.

Preferably, the positioning and laminating device or the electrode string providing device or both of these devices have an application and fixing device for applying and fixing electrode segments, which are supplied in a position relative to one another, to the separator web.

Preferably, the transport system or transport systems each have transport units with exchangeable product carriers, in order to adapt the transport system to different electrode segment formats by exchanging product carriers.

Preferably, the transport system or transport systems are each adapted to hold the electrode substrate in the web-like and/or separated configuration in a targeted manner by means of vacuum on the individual transport units for transportation and cutting.

Preferably, the transport system or systems each have means, embodied as software, for adjusting a distance between cut electrode segments by means of relative movement of the transport units, in order to position the electrode segments relative to one another.

The cutting device is preferably adapted for cutting on a flat surface. The cutting device is preferably adapted for cutting along a flat cutting contour for forming side edges of the electrode segment. The cutting device is preferably adapted for cutting by means of a steered laser beam. The cutting device is preferably adapted to cut out arrester tabs on at least one side edge of the electrode segment. The cutting device is preferably adapted to perform a two-dimensional laser cut within the cutting plane.

Preferably, the positioning and laminating device, in particular its application and fixing device, includes a heating device for targeted heating of the electrode segments.

Preferably, the positioning and laminating device, in particular its application and fixing device, comprises a transport device for transporting and lifting the electrode segments, which are positioned relative to one another, from a delivery plane to a laminating point.

Preferably, the positioning and laminating device, in particular its application and fixing device, comprises a vacuum heating roller or tempered roller or externally tempered vacuum roller.

Preferably, the positioning and laminating device, in particular its application and fixing device, comprises a preferably uncoated laminating roller. In some embodiments, the laminating roller may also be coated.

Preferably, the positioning and laminating device, in particular its application and fixing device, comprises a pressing device for exerting a pressing force for laminating, in particular for exerting a predetermined pressing force on the laminating roller.

In some embodiments, the positioning and laminating device is designed to omit a second electrode segment at a plurality of locations, so that in the composite string formed by the positioning and laminating device, an end cell region is formed at each of the plurality of locations, which end cell region has a layered structure consisting of a length section of the first separator web, the first electrode segment and a length section of the second separator web, but no second electrode segment.

In some embodiments, the separator device is designed to separate the end cell regions from the composite string in order to obtain end cells that have a layered structure of separator, first electrode and separator.

Preferably, the mono-cell manufacturing device has a control system that is designed to control the mono-cell manufacturing device to carry out the mono-cell manufacturing method according to one of the above-described configurations.

According to a further aspect, the invention provides a cell stack manufacturing device comprising a mono-cell manufacturing device according to one of the above configurations and a stacking device for stacking a plurality of mono cells manufactured by the mono-cell manufacturing device to form a cell stack.

In some embodiments, the stacking device is adapted to begin or end the stacking of each cell stack with an end cell, such that each battery cell stack closes with a first electrode and a separator at each end.

It is preferred that the stacking device comprises a plurality of stacking positions that are arranged one behind the other in a transport direction of the mono cells, or also optionally of the end cells.

It is preferred that the stacking device includes a cell detection and counting device for detecting the number of cells at one or more stacking positions.

Preferably, the positioning and laminating device is designed to flexibly create an empty section in response to a control command.

Preferably, the positioning and laminating device is designed to create empty sections depending on a number of cells in one or more of the battery cell stacks formed by the stacking device.

Preferably, the positioning and laminating device is designed to create empty sections depending on a filling level of stacking positions of the stacking device.

It is preferred that the first electrode string providing device comprises a first electrode web delivery device for delivery of a web-like first electrode substrate, and the positioning and laminating device comprises a second electrode web delivery device for delivery of a web-like second electrode substrate, wherein the electrode string providing device and the positioning and laminating device are controlled in such a way that the first electrode substrate is delivered at a higher speed than the second electrode substrate.

The different speeds can compensate for different material requirements for the first and second electrode substrates when creating empty positions.

According to a further aspect, the invention provides a computer-implemented controller for a device of one of the preceding types, adapted to control the device to perform the method according to one of the embodiments described above.

Preferably, the controller is provided with a processor and memory in which a computer program with corresponding instructions is stored.

According to a further aspect, the invention provides a computer program comprising instructions that cause a device according to one of the above types to carry out the method according to one of the embodiments described above.

Further reference is made to the following references, which are not yet published and which are part of the present disclosure:
[6] German patent application DE 10 2023 110 842.5
[7] European patent application EP 23184281.6
[8] German patent application DE 10 2023 110 843.3
[9] European patent application EP 23184279.0
[10] German patent application DE 10 2023 110 844.1
[11] European patent application EP 23184280.8

Some embodiments of the present invention are further developments of embodiments of one or more of references [6] to [11] and comprise, in addition to features according to the invention or features of preferred embodiments of the invention, features that are otherwise described for the respective embodiment of the reference.

Advantageous embodiments of the invention relate to methods and devices for manufacturing mono cells. Preferably, they should be used in the stack assembly of lithium-ion battery cells. Some embodiments relate to the manufacture of mono cells from a pre-produced half-cell string, a single electrode and a web-like separator.

In preferred embodiments of the invention, no pre-positioning of the electrodes on a vacuum belt is necessary. The problem described in [3], that the second electrodes can shift on the way to a laminating point on the separator, does not exist.

In some embodiments of the invention, the distances between the electrodes are variably adjustable, in particular between two successive electrodes, without having to adapt the processing speed in a highly dynamic manner.

In some embodiments, it is possible to omit individual electrodes for an SAS package (separator-anode-separator) or an SKS package (separator-cathode-separator).

Preferred embodiments of the invention differ from the process sequence of the methods known from reference [4]. In the preferred embodiments, a string is first formed consisting of a separator and first electrode segments, which are combined in a second step with a second separator and second electrode segments to form a mono cell.

Embodiments of the invention which are particularly preferred are further developments of the methods, devices, controllers and computer programs described in references [6] to [11].

A basic idea of the previous methods, devices, controllers and computer programs for the production of mono cells and cell stacks or fully aligned battery cell stacks described in [6] to [11] resides in guiding the separated electrodes in a mechanically precise manner.

In the solutions described in [6] to [11], a vacuum drum with individual cassettes is provided as a central element for the precise guidance of the separated electrodes. The first or second electrode segments, which are particularly designed as electrode sheets, are permanently held there from the step of laser cutting until lamination, so that there is no positional loss. In this process, first electrode segments are laminated on a first separator web to create a first half-cell string, while second electrode segments are laminated in parallel on a second separator web to create a second half-cell string. The two half-strings are then laminated together.

However, this requires precise alignment of all mechanical components. The distances between the individual electrodes must not vary and they must be identical in both half-cell strings, otherwise no exact mono cells can be formed when the two half-cell webs are superimposed. The lamination to a mono cell has the conceptual difficulty that there is no possibility for correction, so that the individual half-cells are precisely superimposed. The entire concept depends on the individual electrode sheets being applied exactly and, above all, identically to the two individual separator strings.

Currently, a mono-cell string is produced from two half-cell strings. Some of the technical features of the method described in [6] to [11] are stated below:

The variability of the center distance between the electrodes should be given during operation in order to compensate for variations in individual processes

Lamination should take place continuously, without variations in the web tension

Lamination takes place between two cylindrical rollers that have an uninterrupted surface (except for vacuum holes)

Lamination of two half-cell strings requires precise controllability of the individual half-cell strings

The following points are added as expansions to the previous solution:

An SAS package or SKS package, which is necessary as a top layer in the battery cell, can be variably produced inline by omitting an electrode.

Format flexibility is made possible by a flexible transport system

The use of a “sacrificial film” in the lamination process should also be integrable

Preferred embodiments of the invention offer the advantages of the solutions known from [6] to [11], but are improved in terms of process technology, in particular to avoid or reduce their disadvantages.

Some embodiments of the invention further develop the solutions according to [6] to [11] with regard to an improved production of the mono cell. In [6] to [11], in particular, the production of a half-cell, a separation and transfer of the electrodes, and the production of an S-A-S package (or alternatively an S-K-S package) are already described.

Preferred embodiments of the invention have as an essential feature or as an essential difference to the prior art the positioning and direct lamination of the second electrode segments together with the second separator web onto the first electrode string or, in other words, the positioning and direct lamination of the second electrode together with the second separator onto the first half-cell.

Some advantages of preferred embodiments are explained in more detail below.

In the case of embodiments of the invention, one of the lamination processes (production of the second half-cell) is no longer necessary, which has a positive influence on cell function, but also offers advantages in terms of plant costs and footprint.

In the embodiments of the invention, interferences in the production of the mono cell are reduced by minimizing the web sections in the feed or by direct production (positioning & laminating) of the mono cell from a half-cell string, an electrode and a separator.

In summary, the total length of the web is significantly shorter in the methods according to the embodiments of the invention—e.g., compared to [6] to [11]—because a separate web consisting of the half-cell, the second electrode and the second separator is completely omitted.

In previously known methods, the second electrode is only heated in its actual position in the mono cell, i.e., after being placed on the separator, and then laminated (see [3] to [5]). To this end, the electrode, which is not yet firmly connected to the separator, must then be guided in combination through a heating section so that it can then be laminated. In addition, it is disadvantageous in terms of the positional accuracy of the individual layers in the mono cell if the separator is heated in the long heating section, as this changes its material properties and thus, among other things, has a negative influence on the web tension. Overall, this effect has a negative impact on the control of the overall process and the positional accuracy of the individual layers in the mono cell.

In contrast, particularly preferred embodiments of the invention provide for the electrodes to be heated before they are combined with the other components. This then also allows direct lamination (see also [6] and [7], where heatable drums are already described). Thus, the second electrode no longer needs to be preheated in a downstream heating section. Consequently, the separator is not preheated by this principle and thus the negative influences on the process are avoided.

Furthermore, the material behavior of the separator has a disadvantageous effect during the production of the mono cell by two half-cell strings (elasticity or different behavior with regard to stretching and “re-stretching”).

Particularly preferred embodiments of the invention have one or more of the following advantages:

The following problems can occur in previous production plants, one or more of which can be improved by advantageous embodiments of the invention:

A laser cut on a three-dimensional surface that is also moving is complicated to set up. In addition, due to the properties of the laser, a larger heat influence zone is created in the material to be separated. In preferred embodiments of the invention, the cut is therefore made on a straight surface.

In preferred embodiments of the invention, the lamination and the cut of the electrodes are carried out independently of each other, since the heat input during the cut can lead to tolerance problems.

In previous production systems, lamination was carried out by a roller with an elastic coating. In preferred embodiments of the invention, this is changed to “hard-hard”. The more effective application of pressure makes it possible to reduce the lamination temperature. In addition, the use of an uncoated roller makes it possible to reduce the mechanical forces acting during lamination.

It should be possible to modify the system without great effort if the battery format to be produced changes.

The material supply is conveniently carried out from a central location, but can also be moved towards the center. A central material storage system should facilitate and largely automate the feeding of the coils and separator rolls into the dry clean room.

The separator usually has a certain overhang beyond the electrodes. The overhang, which is created by a so-called gap between the individual electrodes on the separator web, is replaced in preferred designs by a simpler and more flexible solution in place of the usual mechanical construction with the aid of a slotted guide.

Ideally, the laser cut should be made at “12 o'clock” to avoid contamination of the laser. The aim is to achieve a range between “9 o'clock and 3 o'clock”.

In particularly preferred embodiments of the invention, a transport system with independently movable transport units (such as a mover system with freely movable movers, as is available on the market by Beckhoff XTS, or a transport system from B&R Supertrack) is used to pick up an electrode web (almost endlessly) by vacuum and transport it to the separation point. After the electrode web has been separated into sections, the flexible transport units create the freely adjustable gap between the individual electrode pieces. The separation takes place here on a flat surface. For changing product sizes, other product carriers are mounted on the transport units, and the distance can be adjusted accordingly, either mechanically or via the software for example.

After the laser cut, the separated electrodes are preferably transferred with precise positioning to a vacuum heating roller; other rollers, such as tempered or externally tempered rollers, are also possible.

In preferred embodiments, the points where the electrode webs were joined are not transferred, but can optionally be transferred out. The electrodes are heated on this roller for half-cell lamination or for direct lamination on the first electrode string. This means that the electrodes are no longer heated during the laser cut, with the result that temperature-related length expansions no longer have a negative effect on the accuracy of the laser cut.

The lamination—of the second electrodes on the first electrode string and/or of the first electrodes on the first separator web to form the first half-cell—is carried out according to preferred embodiments of the invention separately from the laser cutting after this transfer in a separate area between the transport roller, such as a vacuum heating roller, and a laminating roller. The lamination can be carried out here between two hard surfaces.

Preferred embodiments of the invention offer one, several or all of the following advantages:
high format flexibility;
“hard-hard” lamination in half-cell production and/or in the direct lamination of the second electrode on the first electrode string;
easier gap control between the electrodes;
no heat influence on the laser cut;
2D laser cut with easier calibration during commissioning or format change; and,
injection of a half-cell into the later stacking process by omitting an electrode after separation by means of the flexible transport system, for example, a SAS package.

### BRIEF DESCRIPTION OF THE DRAWINGS

Examples of embodiments are explained in more detail below with reference to the attached drawings.

FIG. 1 is a schematic overview of an embodiment of a cell stacking device for producing a battery cell stack from a first electrode string and second electrode segments together with a second separator web directly positioned thereon.

FIG. 2 is an enlarged representation of the detail II of FIG. 1.

### DETAILED DESCRIPTION OF THE PREFERRED EMBODIMENTS

Methods and devices for manufacturing mono cells from a first electrode string and second electrode segments together with a second separator web directly positioned and laminated thereon, and for manufacturing a battery cell stack from such mono cells are described in the following with reference to the attached drawings.

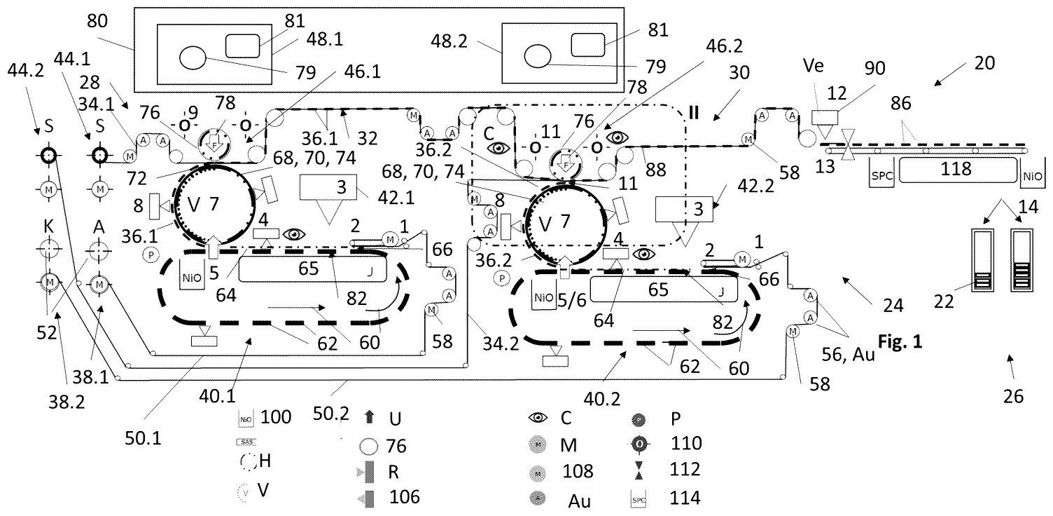

FIG. 1 illustrates an exemplary embodiment of a cell stack manufacturing device 20 for manufacturing a battery cell stack 22. The cell stack manufacturing device 20 includes a mono-cell manufacturing device 24 and a stacking device 26.

The mono-cell manufacturing device 24 includes an electrode string providing device 28 and a positioning and laminating device 30.

The electrode string providing device 28 is used to provide an electrode string 32, which has a first separator layer 34.1 and first electrode segments 36.1 attached to it at a distance from one another. The electrode string 32 with the first electrode segments will also be referred to below as the first electrode string or half-cell string.

The positioning and laminating device 30 is used for positioning and directly laminating second electrode segments 36.2 and a second separator web 34.2 to the first electrode string 32.

The electrode string providing device 28 can be designed in different ways, as long as it provides an electrode string 32 with a first separator web 34.1 and first electrode segments 36.1 attached and fixed to it at a distance from one another. In preferred designs, of which one example is shown in the drawings, the structure of the electrode string providing device 28 and the positioning and laminating device 30 is essentially the same and is described below only once using the example of the positioning and laminating device 30.

In the illustrated embodiment, the positioning and laminating device 30 and the electrode string providing device 28 each comprise an electrode substrate providing device 38.1, 38.2, a transport system 40.1, 40.2, a cutting device 42.1, 42.2, a separator web providing device 44.1, 44.2, an application and fixing device 46.1, 46.2 and a controller 48.1, 48.2.

The electrode substrate providing device 38.1, 38.2 is designed to provide a web-like electrode substrate 50.1, 50.2. For example, the electrode substrate providing device 38.1, 38.2 has a roll holder for a supply roll 52 with the respective web-like electrode substrate 50.1, 50.2 and at least one drive motor 58, M, which is configured for controlling the web tension. Furthermore, a measuring roll 108 is optionally provided, over which the web-like electrode substrate 50.1, 50.2 is guided and which detects the unwinding length and/or the unwinding speed, at which the web-like electrode substrate 50.1, 50.2 is unwound and supplied, and supplies corresponding information to the controller 48.1, 48.2. Data concerning the supply of the web-like electrode substrate 50.1, 50.2 can additionally or alternatively also be determined by means of the position of a dancer (not shown).

In addition, the electrode substrate providing device 38.1, 38.2 in the illustrated embodiments comprises aligning elements 56, such as rollers, and possibly also further drives 58 for driving the movement of the web-like electrode substrate 50.1, 50.2.

The transport system 40.1, 40.2 has individually movable transport units 62 along a circulating guideway 60. The movement of the individual transport units 62 can be controlled individually by the control 48.1, 48.2. The transport system 40.1, 40.2 is designed to receive the web-like electrode substrate 50.1, 50.2 provided by the electrode substrate providing device 38.1, 38.2 and to move it in a planar manner along a cutting plane 64.

For example, the guideway 60 has a straight region adjacent to a receiving location 66, so that the surfaces of workpiece carriers of the transport units 62, on which the electrode substrate 50.1, 50.2 rests and is fixed by means of a vacuum or grippers (not shown) for example, move along the cutting plane 64. In this case, the reference numeral 65 denotes the electrode-fixing region where the electrode substrate 50.1, 50.2 and the electrode segments separated therefrom are fixed to the transport units 62.

In some embodiments, the workpiece carriers mounted on the transport units 62 are connected to a vacuum source (not shown) in the region of the electrode fixing 65 in order to fix the electrode segments 36.1, 36.2 in this region to the transport units 62. In preferred embodiments, a vacuum pump for vacuum generation (not shown) is carried along on the respective transport unit 62, which vacuum pump can be individually controlled via the controller 48.1, 48.2 for example. In further embodiments (not shown), individually controllable grippers are provided on the transport units 62.

Accordingly, in the embodiments shown, the transport system 40.1, 40.2 is designed to hold the electrode substrate 50.1, 50.2 in a targeted manner in the web-like and/or separated form by means of vacuum (or alternatively with other means, such as grippers) on the individual transport units 62 for transport and cutting.

In some embodiments, the transport system 40.1, 40.2 has transport units 62 with exchangeable product carriers in order to adapt the transport system 40.1, 40.2 to different electrode segment formats by exchanging product carriers.

As mentioned above, the movement of the transport units 62 can be controlled individually. In some embodiments, the transport system 40.1, 40.2 for this purpose has means implemented as software in particular in the controller 48.1, 48.2 for setting a distance between cut-off electrode segments 36.1, 36.2 by means of a relative movement of the transport units 62, in order to position the electrode segments 36.1, 36.2 relative to one another.

The cutting device 42.1, 42.2 is designed to cut the electrode substrate 50.1, 50.2 along a one- or two-dimensional cutting contour in the cutting plane 64, in order to cut the electrode segments 36.1, 36.2 from the electrode substrate 50.1, 50.2. For example, the cutting device 42.1, 42.2, as is known in principle from [1], has a cutting laser with corresponding deflection units that are controlled by the controller 48.1, 48.2 to guide the laser beam along the cutting contour.

The cutting device 42.1, 42.2 is designed for cutting on a flat surface. The cutting contour of the cutting device 42.1, 42.2 is designed to shape the side edges of the respective electrode segment 36.1, 36.2. In particular, arrester tabs can also be formed on at least one side edge of the electrode segment 36.1, 36.2 during cutting. This can be done by performing a two-dimensional laser cut within the cutting plane 64.

Since the cutting contour is in a single plane, controlling the cutting beam, including focusing, is much easier than when cutting on a curved cutting surface. Alternatively, other cutting techniques than laser can be used more easily due to the flat progression of the cutting curve.

The separator web providing device 44.1, 44.2 is adapted to provide the separator web 34.1, 34.2. Analogous to the electrode substrate providing device 38.1, 38.2, it can for example have a supply roll 52 with the separator web 34.1, 34.2 and at least one drive 58, which is configured in particular to control the web tension, and optionally also one or more measuring rollers 108 or other measuring sensors, for example for detecting the position of a dancer, the signals of which are also passed to the controller 48.1, 48.2.

The (first) application and fixing device 46.1 of the electrode string providing device 28 is designed to apply and fix first electrode segments 36.1, which are delivered in a manner positioned relative to one another by means of the first transport system, on the first separator web 34.1, 34.2, in order to create the first electrode string 32.

The (second) application and fixing device 46.2 of the positioning and laminating device 30 is designed and configured to directly apply and fix the second electrode segments 36.2, which are delivered in a manner positioned relative to one another by means of the (second) transport system 40.2 of the positioning and laminating device 30, together with the second separator web 34.2 onto the first electrode string 32.

In some embodiments, the application and fixing device 46.1, 46.2 has a heating device 68 for targeted heating of the electrode segments 36.1, 36.2. In some embodiments, the application and fixing device 46.1, 46.2 has a transport device 70 for transporting and lifting the electrode segments 36.1, 36.2, which are positioned relative to one another, from the transport units 62 to a laminating point 72.

In the illustrated embodiments, a vacuum heating roller 74 is provided as the transport device 70 with heating device 68, the surface of which can be heated in a targeted manner by an integrated heater and is provided with suction openings in order to attract the electrode segments 36.1, 36.2 by suction. Alternatively, a tempered roller or an externally tempered vacuum roller can also be provided.

In some embodiments, the application and fixing device 46.1, 46.2 further comprises a preferably uncoated laminating roller 76, which is pressed by the pressing force F of a pressing device 78 onto the transport device 70, in particular the vacuum heating roller 74, in order to laminate the second electrode segments 36.2 together with the second separator web onto the electrode string 32 provided by the electrode string providing means 28 at the positioning and laminating device 30 or to laminate the first electrode segments 36.1 onto the first separator web 34.1 provided by the first separator web providing device 44.1 at the electrode string providing device 32.

In the illustrated embodiments, the laminating roller 76 is driven under the control of the controller 48.1, 48.2. In some embodiments, the movements of the vacuum heating roller 74 and the separator web 34.1, 34.2 are also driven thereby. In other embodiments, the vacuum heating roller 74 is driven in a controlled manner by the controller 48.1, 48.2. It is also conceivable that a laminating roller 76 has no drive of its own. In some embodiments, a tensioning unit with a drive is provided upstream of the laminating roller 76 to generate the web tension of the separator web 34.1, 34.2.

The control device 48.1, 48.2 is designed to control the mono-cell manufacturing device 24 to carry out the mono-cell manufacturing method described below.

The controller 48.1, 48.2 has a processor 79 and a memory 81 with a computer program stored in it that contains the corresponding instructions that cause the units of the electrode string providing device 28 and the positioning and laminating device 30 to carry out this mono-cell manufacturing method. The respective controller 48.1, 48.2 of the electrode string providing device 28 and the positioning and laminating device 30 can be provided as part of an overall control device 80 of the cell stack manufacturing device 20.

The mono-cell manufacturing method is carried out to manufacture mono cells 86 for a battery. The mono cell 86 to be manufactured in each case has an anode segment (example for the first electrode segment 36.1), a cathode segment (example for the second electrode segment 36.2) and a separator layer between the anode segment and the cathode segment, and at least one separator layer on a facing-away surface of the anode segment and/or of the cathode segment (layer structure SASK or SKSA). The mono-cell manufacturing method comprises in particular the steps of:
A) providing an anode string as the first electrode string 32 (half-cell string) having the first separator web S, 34.1 and first electrode segments 36.1 fixed thereto,
B) providing second electrode segments 36.2 in the form of cathode segments and a second separator web S, 34.2 on the first electrode string 32, so that the anode segments and the cathode segments are superposed in alignment with one another (and thus a composite string 88 is formed),
C) cutting the mono cells 86 from the composite string 88 obtained in step B).

In the illustrated configurations of the mono-cell manufacturing device 24, the electrode string providing device 28 is used to provide an anode string provided with anode segments as first electrode segments 36.1 and the positioning and laminating device 30 serves to position, apply and directly laminate cathode segments as second electrode segments 36.2 onto the anode string. The positioning and laminating device 30 is designed to form the composite string 88 from the anode string and the cathode segments positioned and laminated thereon and the second separator web S, 34.2 with anodes and cathode segments lying on top of one another in an aligned manner. Furthermore, a separator device 90 is provided for separating mono cells 86 by cutting them off from the composite string 88.

In the preferred embodiment shown, the provision of the first electrode string 32.1—here, for example, the anode string—according to step A) is carried out with the following steps:
a) providing the web-like first electrode substrate 50.1, here in the form of a web-like anode substrate;
b) picking up the web-like first electrode substrate 50.1 by means of the first transport system 40.1 of the electrode string providing device 28, the first transport system 40.1 including the transport units 62 that are individually movable along the guideway 60, and planar movement of the first electrode substrate 50.1 along the cutting plane 64;
c) cutting the web-like first electrode substrate 50.1 in the cutting plane to cut off first electrode segments 36.1 in the form of anode segments, each of which is individually arranged on one of the transport units 62;
d) setting a distance between cut-off anode segments by means of a relative movement of the transport units 62, in order to position the anode segments 36.1 relative to one another;
e) providing the first separator web 34.1; and
f) applying and fixing the anode segments 36.1, positioned relative to one another, to the first separator web 34.1.

In the region of the anode lamination, the electrodes 36.1 are thus laminated to the separator 34.1 at a defined distance. A laminating roller 76 is installed for this purpose, which applies the necessary counterpressure, for example by means of a pressing device 78. The laminating roller 76 can be heated. At this position, a liner, referred to as a sacrificial film, can optionally be laminated to prevent the first separator 34.1 from adhering to the laminating roller 76. This liner is rewound after lamination.

Accordingly, in some embodiments, step f) is carried out with at least one or more of the following sub-steps:
f1) positionally accurately transferring the separated first electrode segments 36.1 to the transport device 70 with heating device 68, in particular the vacuum heating roller 74;
f2) targeted heating of the first electrode segment 36.1—anode segment—for laminating;
f3) lifting of the first electrode segments 36.1 to a fixing point—laminating point 72—located above the cutting plane 64 and thus outside the region that could be contaminated by cutting particles;
f4) laminating the first separator web 34.1 and the first electrode segments 36.1 between two rollers 74, 76;
f5) laminating the first separator web 34.1 and the first electrode segments 36.1 between uncoated hard metal surfaces and/or between two hard surfaces (e.g. on the rollers 74, 76);
f6) cleaning a side of the first electrode segment 36.1 that has been lifted off the transport unit 62;
f7) pressing the first separator web 34.1 by means of the laminating roller 76 onto the vacuum heating roller 74 or tempered roller or externally tempered vacuum roller that transports the electrode segments 36.1, 36.2.

The anode half-cell string formed in this way—electrode string 32—is transported up to the cathode lamination. At a suitable distance from a second laminating point 11, there is a sensor C that can measure the position of the first electrodes—anode segments—on the first separator 34.1 (center distance between two adjacent electrodes). This sensor C is used to control the positionally accurate transfer of the cathodes to a vacuum drum—example of transport device 70—in order to be able to produce mono cells that fit exactly on top of each other.

In the region of the second laminating point 11, the anode half-cell string, a second separator 34.2, an electrode sheet—example for second electrode segment 36.2, here in particular a cathode sheet—as well as optionally a liner/sacrificial film are fed (instead of, as in the previously performed process, first forming two half cells and then forming the mono cell from them or forming the mono cell from two separators and an electrode with subsequent application of the second electrode and lamination). A mono cell string is produced here in exactly the right position. The sacrificial film is then wound up again.

Step B) is carried out in some embodiments with at least one or more of the following sub-steps:
B1) precise transfer of individual cathode segments to the transport device 70 with heating device 68, in particular the vacuum heating roller 74;
B2) targeted heating of the second electrode segment 36.2, designed as a cathode segment, for laminating;
B3) lifting the second electrode segments 36.2, which are designed as cathode segments, to a fixing point-second laminating point 11—located above the cutting plane 64 in which the second electrode segments 36.2 are separated, and thus outside the area that could be contaminated by cutting particles;
B4) laminating the first electrode string 32 and the second electrode segment 36.2 between two rollers 74, 76, optionally together with the second separator web 34.2;
B5) laminating the first electrode string 32 and the second electrode segment 36.2, optionally together with the second separator web 34.2, between uncoated hard metal surfaces and/or between two hard surfaces;
B6) cleaning of a side of the second electrode segment 36.2 that is lifted off by the transport unit 70 for the delivery of the second electrode segment 36.2;
B7) pressing the first electrode string 32 by means of a laminating roller 76 onto a vacuum heating roller 74 or tempered roller or externally tempered vacuum roller that transports the second electrode segments 36.2.

In addition, step B) is carried out in some embodiments for the precise positioning of the separated cathode segments with at least one or more of the following sub-steps:
i) providing a web-like second electrode substrate 50.2—in the form of a cathode substrate—in order to separate second electrode segments 36.2 in the form of cathodes (analogous to step a));
ii) picking up the web-like second electrode substrate 50.2—cathode substrate—or picking up second electrode segments 36.2—cathode segments—by means of the transport system 40.2, which includes transport units 62 that can be moved individually along the guideway 60;
iii) planar movement of the second electrode substrate 50.2 along the cutting plane 64 and cutting of the web-like second electrode substrate 50.2 in the cutting plane 64, in order to cut off respective second electrode segments 36.2, in particular such that these are each arranged individually on one of the transport units 62 of the transport system 40.2 (as in step c));
iv) setting a distance between the cut-off second electrode segments 36.2 by means of a relative movement of the transport units 62 of the transport system 40.2, in order to position the second electrode segments 36.2 relative to one another (analogous to step d));
v) applying and fixing the second electrode segments 36.2, positioned relative to one another, to the first electrode string 32 (analogous to step f));
vi) providing the second separator web 34.2 and
vi.1) applying and fixing the second separator web 34.2 together with the second electrode segments 36.2 to the first electrode string 32 or vi.2) applying and fixing the second separator web 34.2 to the first electrode string 32, to which the second electrode segments 36.2 are applied and fixed.

In the illustrated exemplary embodiments, steps b) and ii) are carried out in such a way that the respective web-like electrode substrate 50.1, 50.2 is sucked at the pick-up point 66 onto the transport units 62 moving past it and then transported by means of the transport units 62 to a separating point—at reference numeral 3—where the planar movement of the transport units 62 provides a flat surface for cutting as a cutting plane 64 on the transport units 62.

As mentioned above, the transport units 62 are provided with exchangeable product carriers. To set up the cell stack manufacturing device 20 for a particular format of electrodes—anodes and/or cathodes—the product carriers are selected from a range of different product carriers according to the electrode format to be produced.

In the embodiment shown in FIG. 1, a horizontal cutting plane 64 is provided and the electrode substrate 50.1, 50.2 is moved horizontally along the cutting plane. In further embodiments not described in detail, a substantially vertical cutting plane is provided and the electrode substrate 50.1, 50.2 is moved vertically along this vertical cutting plane. Of course, mixed forms are also possible—one of the transport systems 40.1, 40.2 transports the electrode substrate horizontally, the other vertically—or oblique cutting planes are also possible.

In the embodiments shown, cutting is carried out on a flat surface on the product carriers. Cutting is carried out along a flat cutting contour, which is designed at least for forming side edges of the electrode segments 36.1, 36.2 or also for forming arrester tabs or the like. Cutting is carried out in particular by means of at least one guided laser beam that is moved along the cutting contour, although other cutting techniques (e.g., with knives, punches) are of course also possible. Thus, a two-dimensional laser cut is preferably carried out in the cutting plane 64. Preferably, the respective electrode segment 36.1, 36.2 is cleaned after cutting.

The distance between the cut electrode segments is preferably set by the control software according to the distance between the transport units 62 after cutting. For this purpose, the transport unit 62 that is carrying an electrode segment that has just been cut off is moved away from the separating point 82 and moved to a suitable distance from the application and fixing device 46.1, 46.2, where step f) or step v) is carried out. In some embodiments, an electrode segment 36.1, 36.2 can be omitted if necessary at a point on the separator that would otherwise to be filled with an electrode segment, for example by holding back the transport units 62, in order to enable the production of a half-cell such as in particular an SAS or SKS package in the process of producing mono cells. In some embodiments, the cut electrode segment and/or the transport unit are further cleaned.

In addition to the mono-cell manufacturing device, the cell stack manufacturing device is provided with a stacking device 26 that is designed to stack several mono-cells manufactured by the mono-cell manufacturing device 24 to form a cell stack.

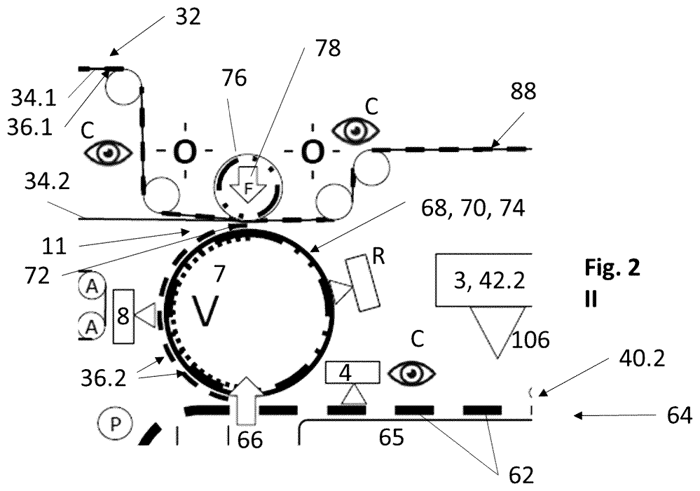

Specific preferred configurations of the cell stack manufacturing method can be seen in FIGS. 1 and 2. The following process steps are shown:
1 feeding electrodes and separators as web material to the cutting and laminating process;
2 mounting the web on a transport system with flexibly movable carriers for the separated electrodes;
3 separating the electrode webs for both the anode and the cathode;
4 optionally cleaning the electrodes;
5 transferring the electrodes to the vacuum roller;
6 optionally, an electrode can be omitted if necessary to provide a half-cell, for example of an SAS package;
7 heating the electrodes;
8 optionally cleaning the electrodes;
9 laminating the half-cells to form two half-cell strings;
10 joining the half-cell strings;
11 laminating the two half-cell strings to form a mono-cell string;
12 separating the mono cells;
13 transferring the mono cells to a conveyor belt for further processing;
14 stacking the mono cells to a battery cell stack;

The symbols used in the drawings have the following meanings:
100 NiO container (NiO=not in order)
106 laser cut
108 measuring roller
110 unwinding/winding sacrificial film
112 HiPot test
114 removal of test pieces
118 stack formation
U transfer to lamination
R cleaning
Ve separation
C monitoring
M drive
Au alignment
P (paper winder/wastebasket autosplice)
H heating
V vacuum
S separator
K cathode (substrate)
A anode (substrate)

At pos. 6, a gap is generated in the composite string 88 for the provision of an SAS package (example for an end cell 100), in which a cathode segment is omitted when it is transferred to the vacuum heating roller 74 of the positioning and laminating device 30. The gap that is generated in the composite string can be used to provide a half-cell in SAS format (anode enclosed in two separators). The normal possible plant speed can still be maintained by using the flexible transport system 40.2 in which the space under the optional electrode cleaning system 4 is used as a buffer for transport units 62 with cathode web pieces on them. If an SAS package is to be produced, the transport unit 62 is held back and no cathode is laminated onto the first electrode string 32, whereby an SAS package is produced by lamination from the second separator and the first separator with an adhering anode. To prevent overfilling of the buffer, the web speed of the as yet unseparated cathode web is permanently lower than the web speed of the unseparated anode web.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 feeding of electrodes and separators as web material to the cutting and laminating process
2 mounting the web onto a transport system with flexibly movable carriers for the separated electrodes
3 separation of the electrode webs for both the anode and the cathode
4 optional cleaning of the electrodes
5 transfer of the electrodes to the vacuum roller
6 optionally, an electrode can be omitted if necessary to provide a half-cell, for example an SAS package
7 heating of the electrodes
8 optional cleaning of the electrodes
9 lamination of half cells to form a first half-cell string
11 lamination of second electrodes and, if necessary, a second separator web on the first half-cell string to form a mono cell string
12 separation of the mono cells
13 transfer of the mono cells to a conveyor belt for further processing
14 stacking of the mono cells to form a battery cell stack
20 cell stack manufacturing device
22 battery cell stack
24 mono-cell manufacturing device
26 stacking device
28 electrode string providing device
30 positioning and laminating device
32 first electrode string (=first half-cell string)
34.1 first separator web
34.2 second separator web
36.1 first electrode segment
36.2 second electrode segment
38.1 first electrode substrate providing device
38.2 second electrode substrate providing device
40.1 first transport system
40.2 second transport system
42.1 first cutting device
42.2 second cutting device
44.1 first separator web providing device
44.2 second separator web providing device
46.1 first application and fixing device
46.2 second application and fixing device
48.1 first controller
48.2 second controller
50.1 first web-like electrode substrate
50.2 first web-like electrode substrate
52 supply roll
56 alignment element
58 drive
60 guideway
62 transport unit
64 cutting plane
65 electrode fixing
66 receiving point
68 heating system
70 transport system
72 laminating point
74 vacuum heating roller
76 laminating roller (laminating drum)
78 press system
79 processor
80 overall control system
81 memory
82 separation point
86 mono cell
88 mono-cell string
90 separator device
100 NiO container (NiO=not in order)
106 laser cutting
108 measuring roller
110 unwinding/winding of sacrificial film
112 HiPot test
114 removal of test pieces
118 stack formation
U transfer to lamination
R cleaning
Ve separation
C control
M drive
Au alignment
P ejection of electrode
H heating
V vacuum
S separator
K cathode substrate
A anode substrate

Claimed is:

1. A method for manufacturing mono cells for a battery, each mono cell having a first electrode segment, a second electrode segment, a separator layer between the first electrode segment and the second electrode segment, and at least one separator layer on a facing-away surface of the first electrode segment, or the second electrode segment, or both, the method comprising the steps of:
A) providing a first electrode string having a first separator web and first electrode segments attached and fixed thereto at a distance from one another;
B) positioning and direct lamination of second electrode segments and a second separator web on the first electrode string so that first and second electrode segments are superposed in alignment with one another as a composite string; and,
C) cutting mono cells from the composite string obtained in step B).

2. The method according to claim 1, wherein step B) comprises at least one or more of the steps:
B1) transferring individual second electrode segments in a precisely positioned manner onto a transport device with heating device;
B2) targeted heating of a second electrode segment;
B3) lifting of the second electrode segments onto a fixing point located above a cutting plane in which the second electrode segments are separated;
B4) laminating the first electrode string and the second electrode segments between two rollers;
B5) laminating the first electrode string and the second electrode segments between uncoated hard metal surfaces, or between two hard surfaces, or both;
B6) cleaning one side of a second electrode segment that has been lifted by a transport unit for delivery of the second electrode segment;
B7) pressing the first electrode string with a laminating roller onto a vacuum heating roller or tempered roller or externally tempered vacuum roller that transports the second electrode segments.

3. The method according to claim 1, wherein step B) comprises at least one or more of the steps of:
i) providing a second electrode substrate to separate second electrode segments therefrom;
ii) picking up a second electrode substrate or picking up second electrode segments with a transport system which has transport units configured to be moved individually along a guideway;
iii) planar movement of a second electrode substrate along a cutting plane and cutting of the second electrode substrate in the cutting plane in order to cut off second electrode segments;
iv) setting a distance between second electrode segments with a relative movement of transport units of a transport system in order to position the second electrode segments relative to one another;
v) applying and fixing the second electrode segments, which are positioned relative to one another, to the first electrode string;
vi) providing a second separator web; and
vi.1) applying and fixing a second separator web together with the second electrode segments on the first electrode string or vi.2) applying and fixing a second separator web on the first electrode string to which the second electrode segments are applied and fixed.

4. The method according to claim 3, wherein step ii) comprises at least one or more of the steps:
ii.1) sucking the second electrode substrate or already separated second electrode segments at a pick-up point onto the transport units;
ii.2) transporting the second electrode substrate with the transport units to a separating point where a flat surface for cutting is provided as a cutting plane;
ii.3) providing transport units having exchangeable product carriers, the product carriers being selected from a range of different product carriers according to an electrode format of the second electrode segments.

5. The method according to claim 3, wherein step iii) comprises at least one or more of the steps:
iii.1) providing a horizontal cutting plane and movement horizontally along the cutting plane;
iii.2) providing a substantially vertical cutting plane and movement along that cutting plane;
iii.4) cutting on a flat surface;
iii.5) cutting along a flat cutting contour to form side edges of a second electrode segment;
iii.6) cutting with a guided laser beam;
iii.7) cutting out arrester tabs at at least one side edge of a second electrode segment;
iii.8) performing a two-dimensional laser cut within the cutting plane;
iii.9) cleaning a second electrode segment after cutting.

6. The method according to claim 3, wherein step iv) comprises at least one or more of the steps of:
iv.1) adjusting a distance with a control software;
iv.2) moving away a transport unit that carries a second electrode segment that has just been cut from a cutting or separating point;
iv.3) further transporting a second electrode segment to a device for performing step v);
iv.4) omitting a second electrode segment at a point in the electrode string that would otherwise be occupied by a second electrode segment, in order to enable production of a half-cell;
iv.5) cleaning a cut-off second electrode segment, or the transport unit, or both.

7. The method according to claim 1, wherein step A) comprises:
a) providing a first electrode substrate;
b) picking up the first electrode substrate with a first transport system which has transport units configured to be moved individually along a guideway, and moving the first electrode substrate in a planar manner along a cutting plane;
c) cutting the first electrode substrate in the cutting plane to cut off first electrode segments that are each individually arranged on one of the transport units;
d) setting a distance between cut first electrode segments with a relative movement of the transport units in order to position the first electrode segments relative to one another;
e) providing the first separator web;
f) applying and fixing the first electrode segments, positioned relative to one another, to the first separator web.

8. The method according to claim 1, further comprising:
stacking the mono cells to form a cell stack.

9. A device for manufacturing mono-cells, the device comprising:
an electrode string providing device for providing a first electrode string comprising a first separator web and first electrode segments attached and fixed thereto at a distance from one another,
a positioning and laminating device which is configured to position second electrode segments on the first electrode string in alignment with the first electrode segments and to directly laminate the second electrode segments and a second separator web directly onto the first electrode string to form a composite string, and
a separator device for separating mono cells by cutting mono cells off from the composite string.

10. The device according to claim 9, wherein the electrode string providing device, or the positioning and laminating device, or both each comprise at least one or more of:
an electrode substrate providing device for providing an electrode substrate;
a transport system having transport units configured to be moved individually along a guideway, the transport system being configured to pick up the electrode substrate provided by an electrode substrate providing device and to move the electrode substrate in a planar manner along a cutting plane;
a cutting device for cutting an electrode substrate along a one- or two-dimensional cutting contour in a cutting plane in order to cut electrode segments from the electrode substrate;
a separator web providing device for providing a separator web;
an application and fixing device for applying and fixing electrode segments that are delivered in a manner positioned relative to one another to the separator web.

11. The device according to claim 10, wherein the transport system comprises transport units with exchangeable product carriers, in order to adapt the transport system to different electrode segment formats by exchanging product carriers; or
wherein the transport system is configured to hold an electrode substrate in a targeted manner with a vacuum on individual transport units for transportation and cutting; or
wherein the transport system comprises software for setting a distance between cut electrode segments with a relative movement of the transport units in order to position the electrode segments relative to one another; or,
any combination thereof.

12. The device according to claim 9, wherein the positioning and laminating device comprises at least one or more of the following:
a heating device for a targeted heating of electrode segments;
a transport device for transporting and lifting electrode segments which are positioned relative to one another from a delivery plane to a laminating point;
a vacuum heating roll or tempered roll or externally tempered vacuum roller;
an uncoated laminating roller; and,
a pressing device for exerting a pressing force for laminating.

13. The device according to claim 9, comprising a controller configured to control the device to perform a mono-cell manufacturing method.

14. The device according to claim 9, further comprising:
a stacking device for stacking a plurality of mono cells to form a cell stack.

15. A non-transitory computer readable medium storing instructions that, when executed by a controller, cause a device to carry out the method according to claim 1.
